(19) United States
(12) Patent Application Publication
(10) Pub. No.: US 2014/0154064 A1
(43) Pub. Date: Jun. 5, 2014

(54) THRUST REVERSER DEVICE

(71) Applicant: AIRCELLE, Gonfreville L'Orcher (FR)

(72) Inventors: Xavier BOUTEILLER, Deville Les Rouen (FR); Patrick BOILEAU, Tournefeuille (FR); Peter SEGAT, Courbevoie (FR)

(73) Assignee: AIRCELLE, Gonfreville L'Orcher (FR)

(21) Appl. No.: 14/176,236

(22) Filed: Feb. 10, 2014

Related U.S. Application Data
(63) Continuation of application No. PCT/FR2012/051580, filed on Jul. 5, 2012.

(30) Foreign Application Priority Data
Aug. 8, 2011 (FR) 11/57227

(51) Int. Cl. F02K 1/56

(52) U.S. Cl. CPC F02K 1/566
USPC 415/182.1; 239/265.19

(57) ABSTRACT

A thrust reverser device of a nacelle includes a thrust reversal cowl which moves alternately from a closed position to an open position in which the thrust reversal cowl opens a path within the nacelle and uncovers a flow deflector, and a rear frame supporting deflecting cascades. The flow deflector includes first deflecting cascades distributed over a circumference of the thrust reversal cowl and arranged so that a diverted flow passes, at least in part, through the first deflecting cascades, when the thrust reverser device is in reverse jet. In particular, the rear frame has an extension structure provided with second deflecting cascades which redirect a portion of the diverted flow when the thrust reverser device is in reverse jet.

### CROSS-REFERENCE TO RELATED APPLICATIONS

This application is a continuation of International Application No. PCT/FR2012/051580, filed on Jul. 5, 2012, which claims the benefit of FR 11/57227, filed on Aug. 8, 2011. The disclosures of the above applications are incorporated herein by reference.

### FIELD

The present disclosure relates to a thrust reverser device with flow diverting cascades.

### BACKGROUND

The statements in this section merely provide background information related to the present disclosure and may not constitute prior art.

An aircraft is driven by several turbojet engines each accommodated in a nacelle housing, also, a set of secondary actuating devices linked to its operation and providing diverse functions when the turbojet engine is operated or stopped.

These secondary actuating devices comprise, in particular, a thrust reverser device.

This nacelle is intended to house a turbofan engine capable of generating, via blades of a rotating fan, a hot air flow, originating from the turbojet engine combustion chamber, and a cold air flow circulating outside the turbojet engine through an annular stream of cold air flow.

Upon touchdown of the aircraft, the thrust reverser device is intended for improving the braking ability of the aircraft by redirecting towards the front of the nacelle at least a portion of the thrust generated by the turbojet engine.

In this phase, the thrust reverser device blocks the stream of cold air flow and directs it to the upstream of the nacelle, generating, therefore, a counter-thrust which is added to the braking of the aircraft wheels.

In the case of a thrust reverser device of cascades-type, redirecting the cold air flow associates a reversal cowl, the cascades and, if necessary, thrust reversal flaps.

Redirecting the cold air flow is made by cascades associated with the reversal flaps, the cowl having only a mere sliding function to uncover or cover these cascades.

Indeed, this cowl is movable relative to a fixed structure of the nacelle between, on the one hand, a deployed position wherein it opens in the nacelle a path intended for diverted air flow, and on the other hand, a retracted position wherein it closes this path.

The reversal flaps, in turn, form blocking doors that can be activated by the cowl sliding resulting in a closure of the stream downstream of the cascades, so as to optimize the cold air flow redirection.

As for the cascades, they are accommodated in the cowl when the reverser is not actuated, that is in direct jet position.

They are divided into a plurality of longitudinal segments arranged circumferentially along the periphery of the thrust reversal cowl.

Each of these segments comprises a plurality of flow deflecting vanes spaced apart, extending along the longitudinal axis of the nacelle, these vanes being configured to redirect the flow to the upstream of the device when the reverser is in reverse jet position.

More particularly, each of the segments of the deflecting cascades is attached, at an upstream end, to the fixed structure of the nacelle and, more particularly, to its front frame and, at a downstream end, to a rear frame mounted also on the fixed structure of the nacelle.

Such a rear frame connects the various segments of deflecting cascades with each other and allows preventing, in particular, any risk of bending of the diverting cascades.

This rear frame does not take part, generally, in the air flow deflection.

In the recent nacelles, especially for aerodynamic optimization reasons, the reversal cowl dimensions should be as small as possible.

More particularly, the internal as well as the external streamlines delimiting the cowl are getting shorter and tighter: this is particularly critical in the case of large nacelles.

Yet, this optimization of the cowl dimensions causes problems in accommodating the deflecting cascades and rear frame assembly in the reversal cowl.

The rear frame, the presence of which influences the length of the deflecting cascades and rear cowl assembly, interferes with the cowl streamlines.

Moreover, in order to maintain its function of deflecting cascades reinforcement, the rear frame thickness cannot be reduced indefinitely without risk of weakening the assembly.

Consequently, the rear frame thickness limits the reduction of the cowl dimensions and, in particular, its radial thickness.

### SUMMARY

The present disclosure provides a rear frame integrated into the thrust reverser device, while complying with the requirements concerning the reduction of the cowl dimensions and, more generally, the thrust reverser device.

The thrust reverser device improves the aerodynamic performance of the aircraft propulsion assembly.

Another advantage of the present disclosure is to provide a nacelle wherein the space available for the deflecting cascades in the thrust reverser device is improved.

The present disclosure provides a thrust reverser device of a nacelle, comprising at least
a thrust reversal cowl movable in translation and able to move alternately from a closed position in which it provides the aerodynamic continuity of the nacelle and covers the flow deflection means, to an open position in which it opens a path in the nacelle and uncovers the flow deflection means,
flow deflection means through the path comprising a plurality of first deflecting cascades distributed around the cowl circumference and arranged so that the deflected flow passes, at least partially, through said cascades,
a rear frame supporting a downstream end of at least one deflecting cascade.

The thrust reverser device being remarkable in that the rear frame comprises at least one extension structure provided with second deflecting cascades that redirect a portion of the deflected flow when the device is in reverse jet, said structure extending the first deflecting cascades.

Thanks to the present disclosure, the rear frame no longer interferes with the external and internal lines of the thrust reversal cowl as it is integrated, henceforth, in the deflecting cascades, upstream of a rear frame of the prior art.

Indeed, the rear frame being mounted at an intermediate position of the deflecting cascades length in a space of the reversal cowl wherein the radial thickness of the cowl is more important, and no more downstream of the deflecting cascades, the rear frame is no longer an obstacle to the thinning of the downstream portion of the thrust reversal cowl.

Furthermore, the rear frame provided with flow deflecting vanes plays an aerodynamic role in the flow deflection performed by the thrust reverser device.

Such a rear frame allows improving as much as possible the deflecting cascades length and helps, thus, improving the device aerodynamic performances.

A device according to the present disclosure may comprise one or more of the following technically possible features, taken separately or in combination:
the extension structure of the deflecting cascades is mounted at the downstream end of the rear frame;
the rear frame is mounted downstream of the furthest downstream vane of the first deflecting cascades;
the second deflecting cascades are disposed on the circumference of the rear frame;
the second deflecting cascades may be angularly spaced apart from each other and/or adjoined to one another;
the second deflecting cascades can extend parallel to the sliding axis of the cowl and/or be obliquely oriented relative to this axis;
the second deflecting cascades can be fixed or movable in translation, independently or not of the first upstream deflecting cascades and/or the cowl;
the rear frame is designed so as to release one or more spaces between the second deflecting cascades to accommodate means for actuating and/or guiding the cowl; and
the rear frame and the first deflecting cascades comprise complementary snap means.

The present disclosure further relates to a nacelle of a turbofan engine comprised of a thrust reverser device as mentioned above.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a partial cross-section view of one form of a thrust reverser device according to the present disclosure;

FIG. 2 is a perspective view of the thrust reverser device of FIG. 1;

FIG. 3 is a perspective view of a deflecting cascades/rear frame assembly of the thrust reverser device of FIG. 2, being assembled;

FIG. 4 is a perspective view of the deflecting cascades/rear frame assembly of FIG. 3 assembled; and

FIG. 5 is a perspective view of the deflecting cascades/rear frame assembly of FIG. 3 mounted on a fixed structure of the thrust reverser device according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The terms upstream and downstream used hereinafter are defined in relation to the direction of the flow passing through the thrust reverser device.

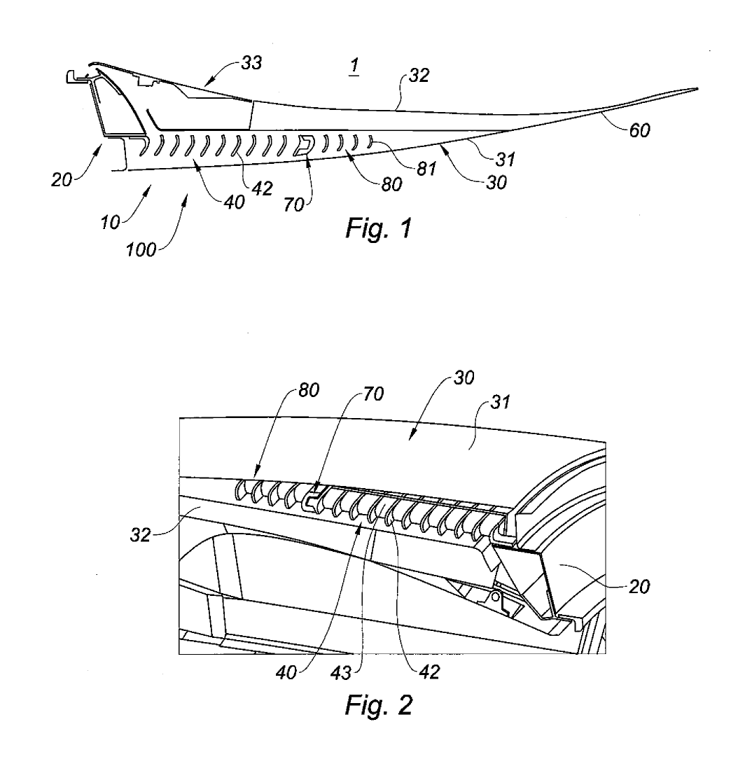

With reference to FIG. 1 which illustrates a downstream section of a nacelle, an external structure 10 is shown, comprising a thrust reverser device 100 and an internal structure (not shown) of an engine fairing, defining with the external structure 10 a stream 1 for the circulation of a cold flow, in the case of a turbofan engine nacelle as presented herein.

The thrust reverser device 100 illustrated in this fig. is a cold flow deflecting cascades-type reverser.

This device 100 comprises a movable cowl 10 mounted in translation, according to a direction substantially parallel to a longitudinal axis of the nacelle, with respect to a fixed structure of the nacelle comprising at least a front frame 20.

This cowl 30 is, also, extended by at least one ejection nozzle section 60 intended to channel the cold flow ejection, mounted at a downstream end of said cowl 30.

More specifically, the cowl 30 comprises an outer shell 31 and an inner shell 32 which is in continuity with the front frame 20 and is meant to delimit, in a direct jet position of the turbojet engine, an outer wall of the stream 1 in which the cold flow is flowing.

Conventionally, the cowl 30 is able to move alternately from a closed position in which it provides the aerodynamic continuity of the nacelle with the front frame 20 and covers first deflecting cascades 40, to an open position, downstream of the nacelle, in which it opens a path in the nacelle and uncovers the first deflecting cascades 40. FIG. 1 illustrates this cowl 30 in the closed position.

In its open position, the cowl 30 allows the flow of the turbojet engine to escape at least partially, this flow portion being redirected to the upstream of the nacelle, in particular by the first uncovered deflecting cascades 40, thereby generating a counter-thrust capable of assisting the aircraft braking.

In one form of the thrust reverser device 100, in order to increase the flow portion passing through the deflecting cascades, the inner shell 32 of the cowl 30 can comprise a plurality of reversal flaps 33, distributed over its circumference and each rotatably mounted about a hinge axis through an end, on the sliding cowl 30, between a retracted position in which the flap 34 closes the opening and provides the internal aerodynamic continuity of the stream 1 with the front frame 20 and a deployed position in which, in case of thrust reversal, it closes off at least partially the stream 1 in order to divert the cold flow towards the cascades 40.

Concerning the first deflecting cascades 40 named upstream deflecting cascades of the thrust reverser device 100, these latter divert the cold flow of the stream 1 through the reversal path or well uncovered after a translation to the downstream of the cowl 30.

As illustrated in FIG. 1 or 2, it is housed in the thickness of the cowl 30 in a housing delimited by the outer shell 31 and inner shell 32 of the cowl 30.

These upstream deflecting cascades 40 of the thrust reverser device 100 are arranged circumferentially along the periphery of the cowl 30 facing the reversal well so that the diverted flow passes, at least in part, through it.

In a non-limiting form of the present disclosure, these upstream deflecting cascades 40 are oriented parallel to the longitudinal axis of the nacelle which also corresponds to the travelling axis of the cowl 30.

In an alternative form, however, it can be oblique with respect to these axes.

Moreover, as shown in FIG. 1 or 5, in one form of the present disclosure, these upstream deflecting cascades 40 are fixed relative to the fixed structure of the nacelle, and more particularly, relative to the front frame 20 and relative to the upper and lower longitudinal beams (not shown) of the fixed structure.

In another form, however, the cascades can be movable in translation along the longitudinal axis of the nacelle with the cowl 30 and/or the nozzle 60 or independently of the latter.

Thus it can be housed, in a retracted position, in part in the thickness of the cowl 30 when the latter is in the closed position and, in part in the thickness of the middle section of the nacelle (or fixed structure) and, slide downstream of the nacelle, in a deployed position, in the reversal well, during the thrust reversal.

As shown in FIGS. 1 to 5, in a conventional way, each upstream deflecting cascade 40 is in the form of one or more longitudinal segment(s) 41 having a semi-circle section, this segment being formed of axial deflecting vanes 42 and lateral brackets 43 forming a support frame for these blades 42.

The flow deflecting vanes 42 are of curved fins-type, spaced apart along the segment 41 and, in this form, along the longitudinal axis of the nacelle, these fins being adapted to redirect the flow to the upstream of the device to achieve the thrust reversal when the latter is in the reverse jet position.

In the non-limiting form illustrated in the figures, each upstream cascade 40 is comprised of two series of adjacent identical vanes 42 disposed between three parallel side brackets 43.

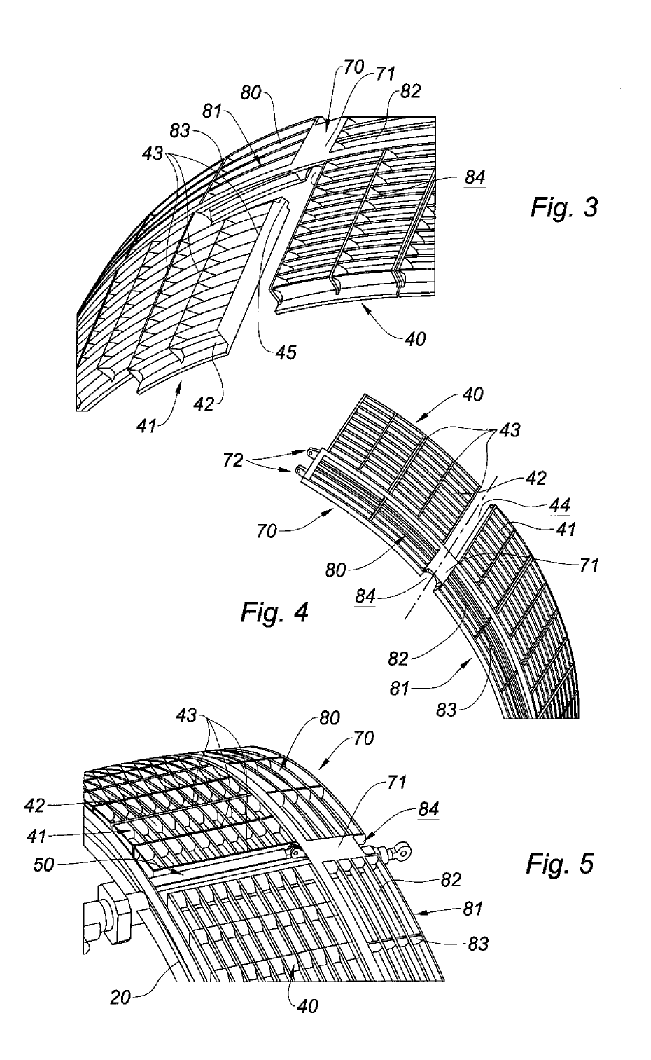

The upstream deflecting cascades 40 can be adjoined to one another (shown in particular in FIG. 3) and/or angularly spaced apart from each other (shown in particular in FIG. 4) so as to provide a gap 44 enabling the passage of means for actuating and guiding the cowl 30 such as jacks 50 (shown in particular in FIG. 5) and/or rails/slides assemblies, depending on the position of cascades 41.

Referring to FIGS. 1 to 5, each of the upstream deflecting cascades 40 can be removably attached, at its upstream end, by appropriate means to the fixed structure of the nacelle and, more particularly, to a structural member of the front frame 20 and, at its downstream end, by appropriate means to a rear frame 70, which is itself housed in the thickness of the cowl 30.

This rear frame 70 attaches the different upstream deflecting cascades 40 to one another.

It is a reinforcement enabling to reduce the risk of bending or twisting the upstream deflecting cascades 40.

According to the present disclosure, this rear frame 70 has an aerodynamic role and, more particularly, contributes to the flow deflection, during the thrust reversal.

More specifically, it is extended, at its downstream end, by an extension structure 80 provided with at least one deflecting cascade 81 named downstream deflecting cascade, adapted, similarly to the first upstream deflecting cascades 40, to redirect a portion of the diverted flow when the device 100 is in the reverse jet position.

These downstream deflecting cascades 81 are arranged in the extension of the upstream deflecting cascades 40.

Thus, the rear frame 70 provided with downstream deflecting cascades 81 and the upstream deflecting cascades 40 form, with thrust reversal flaps 34 if necessary or any other flow blocking means, all the flow deflecting means during a thrust reversal.

The rear frame 70 is mounted downstream of the vane 42 being the furthest downstream vane of the upstream deflecting cascades 40.

The rear frame 70 is, thus, mounted at an intermediate position of the deflecting cascades 40, 80 length, in a space of the reversal cowl 30 wherein the radial thickness of the cowl 30 is greater than in the prior art wherein it was located at the downstream end of the deflecting cascades in the narrow junction region between the external shell 31 and the internal shell 32 of the cowl 30 and, not downstream of the deflecting cascades assembly.

Advantageously, it no longer interferes with the downstream ends of the external 31 and internal 32 shells of the cowl 30 as it is now integrated or embedded in the deflecting cascades 40, 81, upstream of a rear frame of the prior art.

Such a rear frame 70 improves as much as possible the length of the deflecting cascades 40, 81, and thus contributes to improve the aerodynamic performances of the thrust reverser device 100.

More particularly, with reference to FIGS. 1 and 3 to 5, the rear frame 70 has a substantially inverted C-shaped profile the concavity of which is directed towards the first upstream deflecting cascades 40, extended by a longitudinal extension structure 80.

The upstream portion of the rear frame 70, and in particular this concavity, constitutes the interface along with the upstream deflecting cascades 40 and, more particularly, the furthest downstream vane 42 of these cascades 40.

The downstream portion of this rear frame 70 is formed by the cascades extension structure 80.

This rear frame 70 can be achieved by a complete ring or a plurality of ring sections attached to one another to form a continuous structure.

Concerning more particularly the extension structure 80, it comprises, similarly to the upstream flow deflecting cascades 40, a plurality of deflecting cascades 81, each made up of one or more longitudinal segment(s) 83 formed of flow deflecting vanes 82 longitudinally spaced apart and side brackets supporting these vanes 82.

The flow deflecting vanes 82 are, also, of the curved fins-type, spaced apart along the segments 83 and, in this form, along the longitudinal axis of the nacelle, these fins being adapted to redirect the flow to the upstream of the device to perform the thrust reversal when the latter is in the reverse jet position.

The downstream deflecting cascades 81 are oriented parallel to the longitudinal axis of the nacelle. In an alternate form, it can however be oriented obliquely to this axis and/or to the sliding axis of the cowl 30.

Similarly to the upstream flow deflecting cascades 40, the downstream deflecting cascades 81 of the rear frame 70 can be angularly spaced apart from each other or adjoined along the circumference of the rear frame 70.

When a space 84 is provided between two adjacent deflecting cascades 80, the cascades 80 are joined by a ring portion 71 of the rear frame 70 designed to allow the passage of the actuating and guiding means of the cowl 30 such as the jacks 50 (illustrated in FIG. 5) and/or the rails/slides assemblies, depending on the position of the upstream cascades 40 and downstream cascades 80, while providing the continuity of the rear frame 70 on its circumference.

It is thus possible to slide the cowl 30 toward the downstream (reverse jet position) or towards the upstream (direct jet position) of the nacelle.

Furthermore, the rear frame and the extension structure can be fixed relative to the fixed structure of the nacelle or movable in translation along the longitudinal axis of the nacelle downstream of the nacelle and inversely, independently or not from the first upstream deflecting cascades 40, of the cowl 30 and/or nozzle 60.

Moreover, it is observed, in FIGS. 3 to 5, that the downstream deflecting cascades 81 have neither the same length as the downstream deflecting cascades 40, nor the same number of segments 42, 83 nor the same angular dimensions of the deflecting vanes 42, 82.

In this example, the deflecting cascades 80 of the rear frame 70 has each a single series of vanes 82 which extend angularly through a distance identical to the distance of two series of adjoined vanes 42 of a downstream deflecting cascade 40.

This is an example of non-limiting illustration of the present disclosure and alternate forms can provide upstream deflecting cascades 40 and downstream deflecting cascades 81 being identical or not.

Referring to FIG. 4, the rear frame 70 is also designed to be mounted and fixed on the upper and lower beams (not shown) if necessary to the fixed structure, connecting it to a suspension pylon of the turbojet engine.

It can thus comprise any fastening member suitable for this arrangement.

In a non-limiting example illustrated in the figure, two attachment clevis 72 have been provided to cooperate with complementary means provided on the beams (not shown) of the nacelle fixed structure.

Referring more particularly to FIGS. 1 and 3, as for the interface between the downstream end of the upstream deflecting cascades 40 and the upstream end of the rear frame 70, any fastening means of the cascades 40 and the rear frame 70 may be contemplated.

In the example illustrated, the upstream deflecting cascades 40 and the rear frame 70 are provided with complementary snap means. Thus, the upstream deflecting cascades 40 are provided with a flange 45, the shape and dimensions of which are adapted to fit within the concavity of the upstream end of the rear frame 70 and to be snapped thereto.

In an alternate form, any other fastening means can also be provided as, for example, standard fastening means of the screwing means type.

Moreover, the rear frame 70 and the associated cascades extension structure 80 can be formed of a composite material and/or metal alloy.

With a thrust reverser device 100 according to the present disclosure, under a thrust reversal, the cowl 30 slides towards the downstream of the nacelle in open position, uncovering, during its displacement, primarily the upstream deflecting cascades 40 and, then, the rear frame 80 and its downstream deflecting cascades 80.

The flaps 34, if any, are rotated in the closed position of the stream 1 so as to divert the cold flow to the upstream deflecting cascades 40 and downstream deflecting cascades 81 assembly, forming an inverted flow guided towards the upstream of the nacelle by the cascades 40, 81.

The thrust reverser device 100 according to the present disclosure allows, in particular, disposing of a rear frame 70 supporting deflecting cascades 40, 81 in a device whereof the streamlines of the cowl 30 are reduced while maintaining a maximum length of deflecting cascades 40, 81, thus, providing an increase of the passage section of air flow in the stream 1.

What is claimed is:

1. A thrust reverser device of a nacelle, comprising:
a thrust reversal cowl movable in translation and moving alternately from a closed position in which the thrust reversal cowl provides an aerodynamic continuity of the nacelle and covers flow deflecting means, to an open position in which the thrust reversal cowl opens a path within the nacelle and uncovers the flow deflecting means,
said flow deflecting means comprising at least one first deflecting cascade distributed over a circumference of the thrust reversal cowl and arranged so that a diverted flow passes, at least in part, through said at least one first deflecting cascade, when the thrust reverser device is in reverse jet; and
a rear frame supporting a downstream end of said at least one first deflecting cascade,
wherein the rear frame comprises at least an extension structure provided with second deflecting cascades which redirect a portion of the diverted flow when the thrust reverser device is in reverse jet, said extension structure extending said at least one first deflecting cascade.

2. The thrust reverser device according to claim 1, wherein the extension structure of the second deflecting cascades is mounted at the downstream end of the rear frame.

3. The thrust reverser device according to claim 1, wherein the rear frame is mounted downstream of a vane being at the furthest downstream of the at least one first deflecting cascade.

4. The thrust reverser device according to claim 1, wherein the second deflecting cascades are arranged on the circumference of the rear frame.

5. The thrust reverser device according to claim 1, wherein the second deflecting cascades are angularly spaced apart from each other.

6. The thrust reverser device according to claim 1, wherein the second deflecting cascades are adjoined to one another.

7. The thrust reverser device according to claim 1, wherein the second deflecting cascades extend parallel to a sliding axis of the thrust reversal cowl.

8. The thrust reverser device according to claim 1, wherein the second deflecting cascades are obliquely oriented relative to a sliding axis of the thrust reversal cowl.

9. The thrust reverser device according to claim 1, wherein the second deflecting cascades are fixed independently relative to said at least one first deflecting cascade.

10. The thrust reverser device according to claim 1, wherein the second deflecting cascades are movable in translation independently relative to at least one of the first deflecting cascades and the thrust reversal cowl during the thrust reversal cowl's displacements between the closed and open positions.

11. The thrust reverser device according to claim 1, wherein the rear frame releases at least one space between the second deflecting cascades to accommodate at least one of actuating means and guiding means of the thrust reversal cowl.

12. The thrust reverser device according to claim 1, wherein the rear frame and the at least one first deflecting cascade comprise complementary snap means.

13. A nacelle of a turbofan engine comprising a thrust reverser device according to claim 1.
